(19) United States
(12) Patent Application Publication
(10) Pub. No.: US 2008/0126731 A1
(43) Pub. Date: May 29, 2008

(54) Method of executing a default instruction set of a stroage device

(75) Inventors: Hung-Chou Tsai, Jiji Jen (TW); Shih-Hsien Yang, Junghe City (TW); Chi-Tung Chang, Taipei City (TW)

Correspondence Address: HOFFMANN & BARON, LLP, 6900 JERICHO TURNPIKE, SYOSSET, NY, 11791, US

(73) Assignee: ALCOR MICRO, CORP.

(21) Appl. No.: 11/447,415

(22) Filed: Jun. 6, 2006

(51) Int. Cl. G06F 12/00

(52) U.S. Cl. 711/167; 711/E12.001

(57) ABSTRACT

A method of executing a default instruction set of a storage device for conveniently connecting the storage device to a computer includes the following steps: connecting a USB interface of the storage device to a USB interface of the computer; the computer using interface commands to determine a device class of the storage device; a controller of the storage device actuating a built-in Auto Dispatch program and returning a message to the computer that the connected device is a keyboard; the controller sending specific serial keyboard commands to the computer via the Auto Dispatch program; the controller resetting an interface class code setting thereof when the computer has received the specific serial keyboard commands; the computer using the interface commands to check the interface class code setting to identify the storage device; and the controller returning a message to the computer that the connected device is a mass storage device.

### FIELD OF THE INVENTION

The present invention relates to a method of executing a default instruction set of a storage device, and more particularly to a method of executing a default instruction set of a storage device via universal serial bus (USB)

### BACKGROUND OF THE INVENTION

With the prosperously developed electronic technical field, and the increasing demands of consumers on portable storage devices, various types of portable storage devices having largely increased capacity and largely reduced volume have been introduced into the market. Particularly, storage devices with USB interface are highly welcome in the consumptive electronic product market.

In the prior art, some software installation programs may be automatically executed when a CD-ROM reads data from a compact disk. In practical operation, the automatic execution is performed through a built-in auto run function of the CD-ROM. Therefore, in the prior art, the auto dispatch function is basically built in a hardware driver. Such auto dispatch function provided by the CD-ROM might be closed by the registered functions of Windows®, resulting in failed auto run function or rebooting of system.

It is therefore tried by the inventor to develop a method that enables a storage device to directly interact with a computer host via a built-in default instruction set of the storage device, so that the storage device is not restrained by the auto run function of the Microsoft® Windows®, and may therefore be more efficient and convenient for use.

### SUMMARY OF THE INVENTION

A primary object of the present invention is to provide a method of executing a default instruction set of a storage device, so as to solve the problem of a failed auto run function or rebooting of system due to the possible closing of the built-in auto run function of a peripheral by the registered functions of Windows®.

To implement the method of the present invention, the storage device includes a controller having an Auto Dispatch program built therein, and a USB interface. The method includes the following steps:
(1) Connect the USB interface of the storage device to a USB interface of an electronic apparatus;
(2) The electronic apparatus uses a plurality of interface commands to determine a device class of the storage device;
(3) The controller of the storage device actuates the built-in Auto Dispatch program and returns a message to the electronic apparatus that the connected device is a keyboard;
(4) The controller sends a plurality of specific serial keyboard commands to the electronic apparatus via the Auto Dispatch program;
(5) The controller resets an interface class code setting thereof when the electronic apparatus has received the specific serial keyboard commands;
(6) The electronic apparatus uses the interface commands to check the interface class code setting to identify an exact class of the storage device; and
(7) The controller returns a message to the electronic apparatus that the connected device is a mass storage device.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram schematically showing a system for which a method of executing a default instruction set of a storage device according to the present invention is designed and implemented;

FIG. 2 is a flowchart showing the steps included in the method of executing a default instruction set of a storage device according to a first embodiment of the present invention; and

FIG. 3 is a flowchart showing the steps included in the method of executing a default instruction set of a storage device according to a second embodiment of the present invention.

### DETAILED DESCRIPTION OF THE PREFERRED EMBODIMENTS

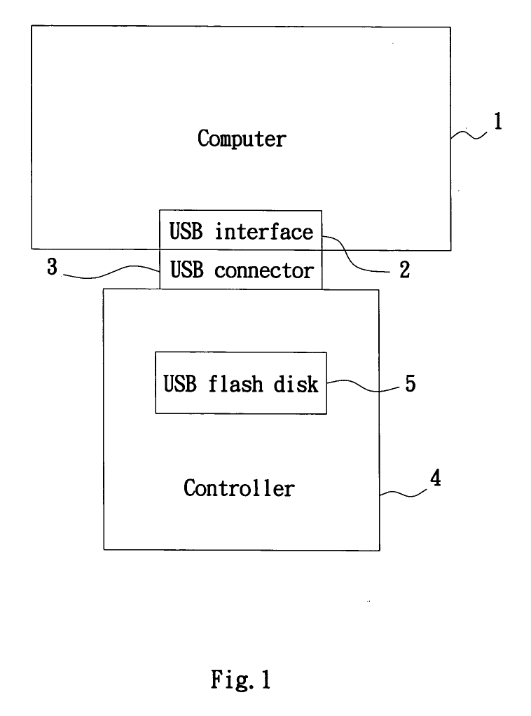

Please refer to FIG. 1 that is a block diagram schematically showing a system for which a method of executing a default instruction set of a storage device according to the present invention is designed and implemented. As shown, the system includes a storage device 4, which is a USB flash disk in the illustrated embodiment; and an electronic apparatus 1, which is a computer in the illustrated embodiment. The USB flash disk 4 is equipped with a controller 5 and a universal serial bus (USB) connector 3, and the controller 5 is a firmware having a built-in Auto Dispatch program. The computer 1 is equipped with a USB interface 2.

In implementing the method of the present invention, the USB flash disk 4 is connected to the computer 1 by plugging the USB connector 3 into the USB interface 2 of the computer 1. The computer 1 uses a plurality of USB interface commands to determine an exact device class of the USB flash disk 4. At this point, the controller 5 of the USB flash disk 4 actuates the Auto Dispatch program, and the USB flash disk 4 uses an interface class code setting, such as bInterfaceClass, to return a message to the computer 1 that it is a keyboard, so that the computer 1 treats the USB flash disk 4 connected thereto as a keyboard. Then, the controller 5 of the USB flash disk 4 sends via the Auto Dispatch program a plurality of specific serial keyboard commands to the computer 1, such as Ctrl+a indicating “to read”, Ctrl+t indicating “to write”, etc. When the computer 1 has received the above-mentioned specific serial keyboard commands, the controller 5 of the USB flash disk 4 resets the interface class code setting thereof, and the computer 1 uses the USB interface commands to check the interface class code setting, so as to identify the exact class of the USB flash disk 4. At this point, the controller 5 of the USB flash disk 4 returns a message to the computer 1 that it is a mass storage device.

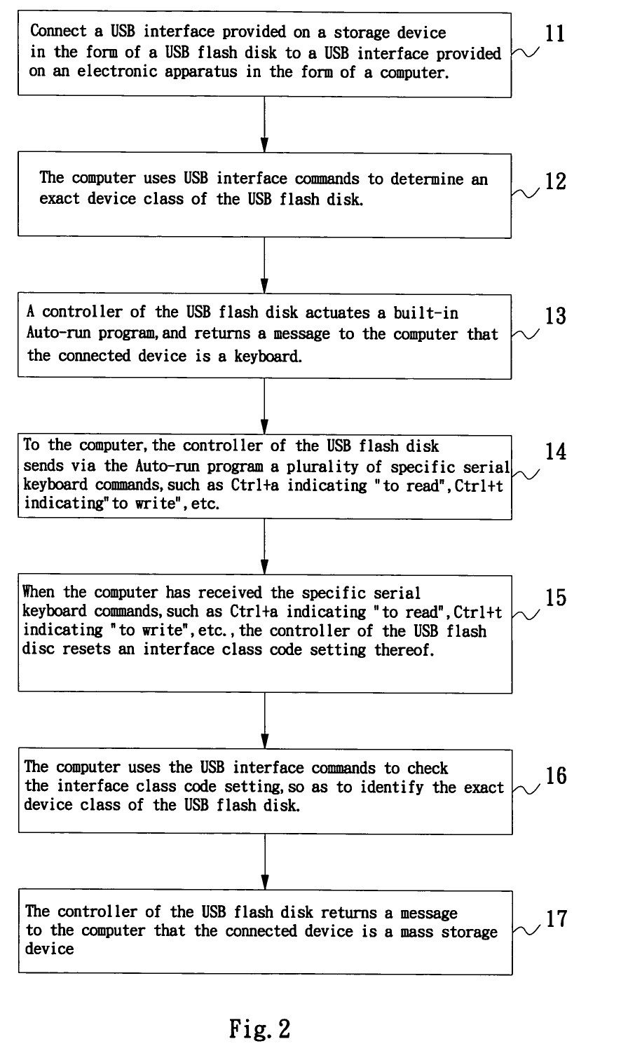

FIG. 2 is a flowchart showing the steps included in the method of executing a default instruction set of a storage device according to a first embodiment of the present invention. As shown, the method in this first embodiment includes the following steps:
(11) Connect a USB interface provided on a storage device in the form of a USB flash disk to a USB interface provided on an electronic apparatus in the form of a computer;
(12) The computer uses a plurality of USB interface commands to determine an exact device class of the USB flash disk;
(13) A controller of the USB flash disk actuates a built-in Auto Dispatch program, and returns a message to the computer that the connected device is a keyboard;
(14) The controller of the USB flash disk sends via the Auto Dispatch program a plurality of specific serial keyboard commands, such as Ctrl+a indicating “to read”, Ctrl+t indicating “to write”, etc., to the computer;
(15) When the computer has received the specific serial keyboard commands, the controller of the USB flash disc resets an interface class code setting thereof;
(16) The computer uses the USB interface commands to check the interface class code setting, so as to identify the exact device class of the USB flash disk; and
(17) The controller of the USB flash disk returns a message to the computer that the connected device is a mass storage device.

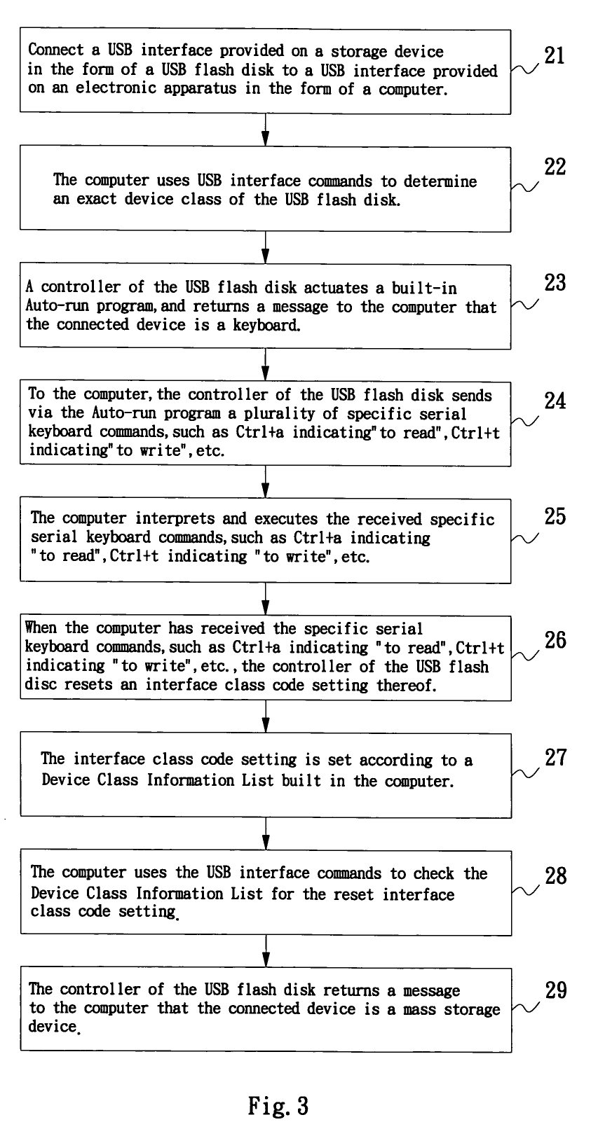

Please refer to FIG. 3 that is a flowchart showing the steps included in the method of executing a default instruction set of a storage device according to a second embodiment of the present invention. As shown, the method of the second embodiment includes the following steps:
(21) Connect a USB interface provided on a storage device in the form of a USB flash disk to a USB interface provided on an electronic apparatus in the form of a computer;
(22) The computer uses a plurality of USB interface commands to determine an exact device class of the USB flash disk;
(23) A controller of the USB flash disk actuates a built-in Auto Dispatch program, and returns a message to the computer that the connected device is a keyboard;
(24) The controller of the USB flash disk sends via the Auto Dispatch program a plurality of specific serial keyboard commands, such as Ctrl+a indicating “to read”, Ctrl+t indicating “to write”, etc., to the computer;
(25) The computer interprets and executes the received specific serial keyboard commands, such as Ctrl+a indicating “to read”, Ctrl+t indicating “to write”, etc.;
(26) After the computer has received the specific serial keyboard commands, such as Ctrl+a indicating “to read”, Ctrl+t indicating “to write”, etc., the controller of the USB flash disc resets an interface class code setting thereof;
(27) The interface class code setting is set according to a Device Class Information List built in the computer;
(28) The computer uses the USB interface commands to check the Device Class Information List for the reset interface class code setting; and
(29) The controller of the USB flash disk returns a message to the computer that the connected device is a mass storage device.

From the above described steps, it is clearly understood that, the method of the present invention for executing a default instruction set of a storage device eliminates the problem of a failed auto dispatch function or rebooting of system due to the possible closing of the auto dispatch function built in the computer peripherals by the registered functions of Windows®. The method of the present invention is characterized in that it enables a storage device, when being connected to a computer, to use a default instruction set built in the storage device for the computer to identify the storage device as a keyboard, so that the storage device may directly interact with the computer, and then uses an interface class code setting for the computer to re-identify the connected device as a storage device, allowing the storage device to be more convenient and efficient for use.

What is claimed is:

1. A method of executing a default instruction set of a storage device, said storage device including a controller having a built-in Auto Dispatch program, and a USB interface; said method comprising the following steps:
(1) Connecting said USB interface of said storage device to a USB interface of an electronic apparatus;
(2) Said electronic apparatus using a plurality of interface commands to determine a device class of said storage device;.
(3) Said controller of said storage device actuating said Auto Dispatch program and returning a message to said electronic apparatus that said connected device is a keyboard;
(4) Said controller sending a plurality of specific serial keyboard commands to said electronic apparatus via said Auto Dispatch program;
(5) Said controller resetting an interface class code setting thereof when said electronic apparatus has received said specific serial keyboard commands;
(6) Said electronic apparatus using said interface commands to check said interface class code setting to identify an exact class of said storage device; and
(7) Said controller returning a message to said electronic apparatus that said connected device is a mass storage device.

2. The method of executing a default instruction set of a storage device as claimed in claim 1, wherein the step (4) further comprising the following step:
(41) Said electronic apparatus interpreting and executing said specific serial keyboard commands.

3. The method of executing a default instruction set of a storage device as claimed in claim 1, wherein the step (5) further comprising the following step:
(51) Said interface class code setting being set in accordance with a device class information list built in said electronic apparatus.
